(19) United States
(12) Patent Application Publication
(10) Pub. No.: US 2025/0326284 A1
(43) Pub. Date: Oct. 23, 2025

(54) VEHICLE REAR STRUCTURE

(71) Applicant: TOYOTA JIDOSHA KABUSHIKI KAISHA, Toyota-shi (JP)

(72) Inventors: Daisuke KUROKAWA, Ckazaki-shi (JP); Yoshiki YASUDA, Bruxelles (BE)

(73) Assignee: TOYOTA JIDOSHA KABUSHIKI KAISHA, Toyota-shi (JP)

(21) Appl. No.: 19/035,861

(22) Filed: Jan. 24, 2025

(30) Foreign Application Priority Data
Apr. 18, 2024 (JP) 2024-067728

(51) Int. Cl. B60K 1/04

(52) U.S. Cl. CPC B60K 1/04; B60K 2001/0433

(57) ABSTRACT

A vehicle rear structure where a high-voltage device is disposed below a seat cushion of a rear seat of a vehicle. The seat cushion includes a cushion frame disposed below a seating surface on which the occupant is seated. The front end of the cushion frame is connected to the floor panel via one or more front legs, and the cushion frame is inclined downward from the front toward the rear. The cushion frame includes a framework member extending in the vehicle width direction and positioned below a thigh portion of the occupant when the occupant is seated on the seating surface. A cross-member bridged between a pair of rear side members extending in the front-rear direction at a rear portion of the vehicle, and a bracket disposed on the cross-member and connected to the framework member are provided.

### CROSS-REFERENCE TO RELATED APPLICATION

This application claims priority to Japanese Patent Application No. 2024-067728 filed on Apr. 18, 2024, incorporated herein by reference in its entirety.

### BACKGROUND

### 1. Technical Field

The present disclosure relates to a vehicle rear structure, and more particularly, to a structure in which a high-voltage device is disposed below a rear seat cushion of a vehicle.

### 2. Description of Related Art

Conventionally, electrified vehicles such as hybrid battery electric vehicles (HEV), plug-in hybrid battery electric vehicles (PHEV), and so forth, are known. Electrified vehicles are equipped with a battery that supplies power to a driving motor. High-voltage devices, including the battery for example, are disposed below a seat cushion of a rear seat. Japanese Unexamined Patent Application Publication No. 2016-37215 (JP 2016-37215 A) discloses a vehicle rear structure that includes a load transmission bar that is disposed below a rear seat cushion of a vehicle, over a vehicle-width direction, and that receives a load in the event of a broadside collision.

### SUMMARY

The seat cushion of the rear seat includes a cushion frame that is disposed below a seating surface on which an occupant is seated. High-voltage devices that include a battery are disposed between the cushion frame and a floor panel. A front end of the cushion frame is connected to the floor panel via one or more front legs, and the cushion frame is inclined downward from forward to rearward. A rear end of the cushion frame is connected to the floor panel. Also, the cushion frame includes a framework member, such as a pipe or the like, that extends in the vehicle-width direction and that is situated below the thighs of the occupant when seated on the seating surface.

In the event of a frontal collision of the vehicle, an occupant may be seated on the rear seat. In this case, when the buttocks of the occupant move forward while sinking into the seat cushion due to the inertial force accompanying the collision, in this structure the buttocks of the occupant are received by the framework member extending in the vehicle-width direction, via the cushion material. However, at this time, the framework member is deformed downward due to a load from the occupant, or the framework member is deformed, such that the load applied to the front leg of the rear seat increases and the front leg is deformed. Consequently, the seat cushion may be displaced downward, and a lower face of the seat cushion may come near to the high-voltage devices.

An object of the present disclosure is to suppress a seat cushion of a rear seat from coming near to a high-voltage device in the event of a frontal collision of a vehicle.

In a vehicle rear structure according to the present disclosure, a high-voltage device is disposed below a seat cushion of a rear seat of a vehicle.

The seat cushion includes a cushion frame that is disposed below a seating surface on which an occupant is seated.
The high-voltage device is disposed between the cushion frame and a floor panel.
A front end of the cushion frame is connected to the floor panel via one or more front legs.
The cushion frame is inclined downward from forward to rearward, and a rear end of the cushion frame is connected to the floor panel, and
the cushion frame includes a framework member that extends in a vehicle-width direction and that is situated below the thighs of the occupant when the occupant is seated on the seating surface.

The vehicle rear structure includes

a cross-member that bridges between a pair of rear side members extending in a front-rear direction in a rear portion of the vehicle, and
a bracket that is disposed on the cross-member and that is connected to the framework member.

According to this configuration, in the event of a frontal collision of the vehicle, the load input to the framework member from the occupant sitting on the rear seat is received by the cross-member via the bracket. Thus, downward deformation of the framework member, and deformation of the front leg due to deformation of the framework member, can be suppressed. Accordingly, the seat cushion can be suppressed from coming near to the high-voltage device.

In the vehicle rear structure according to the present disclosure, the bracket may be provided below a vehicle-width-direction middle portion of a seating surface region on which the occupant is seated.

According to this configuration, the bracket is provided in the portion of the framework member at which the load input from the occupant is great in the event of a frontal collision of the vehicle, and accordingly downward deformation of the framework member can be effectively suppressed.

In the vehicle rear structure according to the present disclosure, the bracket may include an upper bracket that is welded to the framework member, and a lower bracket that is bolted to the upper bracket and also is bolted to the floor panel that is disposed above the cross-member.

According to this configuration, degree of freedom in assembling the bracket at the time of manufacturing the vehicle can be increased. For example, the lower bracket can be bolted to the floor panel in advance, following which the lower bracket can be bolted to the upper bracket at a relatively high position. Conversely, after the lower bracket is bolted to the upper bracket in advance, the lower bracket can be bolted to the floor panel at a relatively low position.

In the vehicle rear structure according to the present disclosure,

the framework member may be a pipe,
the upper bracket may include a bottom plate and two side plates extending upward from right and left end portions of the bottom plate,
the bottom plate of the upper bracket may be bolted to the lower bracket, and
a forward end face of each of the two side plates of the upper bracket may be welded to an outer peripheral face on a rearward lower portion of the pipe, and also the two side plates may be bent outward at an upper end to the right and left to create flange portions that face a lower face of a cushion material of the seat cushion.

According to this configuration, the upper bracket and the pipe can be joined in a simplified manner, and also the cushion material of the seat cushion, which descends under the load of the occupant in the event of a frontal collision of the vehicle, can be supported by the flange portions of the upper bracket.

According to the present disclosure, the seat cushion of the rear seat can be suppressed from coming close to the high-voltage device in the event of a frontal collision of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view showing a vehicle rear structure;

FIG. 2 is a cross-sectional view taken along line 2-2 of FIG. 1;

FIG. 3A is a diagram for explaining the connecting construction of the cross-member and the floor panel;

FIG. 3B is a diagram for explaining the connecting construction of the cross-member and the floor panel;

FIG. 3C is a diagram for explaining the connecting construction of the cross-member and the floor panel;

FIG. 4 is a perspective view showing a bracket;

FIG. 5 is a front view showing a lower bracket

FIG. 6 is a cross-sectional view taken along line 6-6 of FIG. 4; and

FIG. 7 is a perspective view of another embodiment of a bracket.

### DETAILED DESCRIPTION OF EMBODIMENTS

Hereinafter, embodiments of the present disclosure will be described with reference to the drawings. The present disclosure is not limited to the embodiment described below. In all the drawings, the same elements are denoted by the same reference numerals, and redundant description is omitted. In the following description, unless otherwise specified, the terms indicating the front-rear, right-left, and up-down, etc. directions indicate the directions related to a vehicle. In the drawings, the direction of the arrow FR indicates the front side, the direction of the arrow UP indicates the upper side, and the direction of the arrow RH indicates the right side.

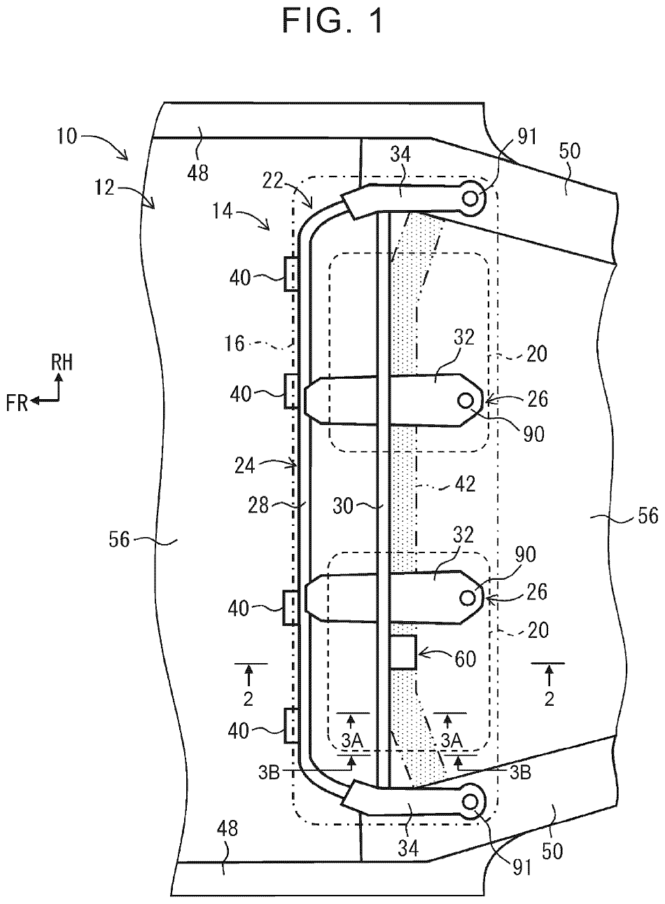

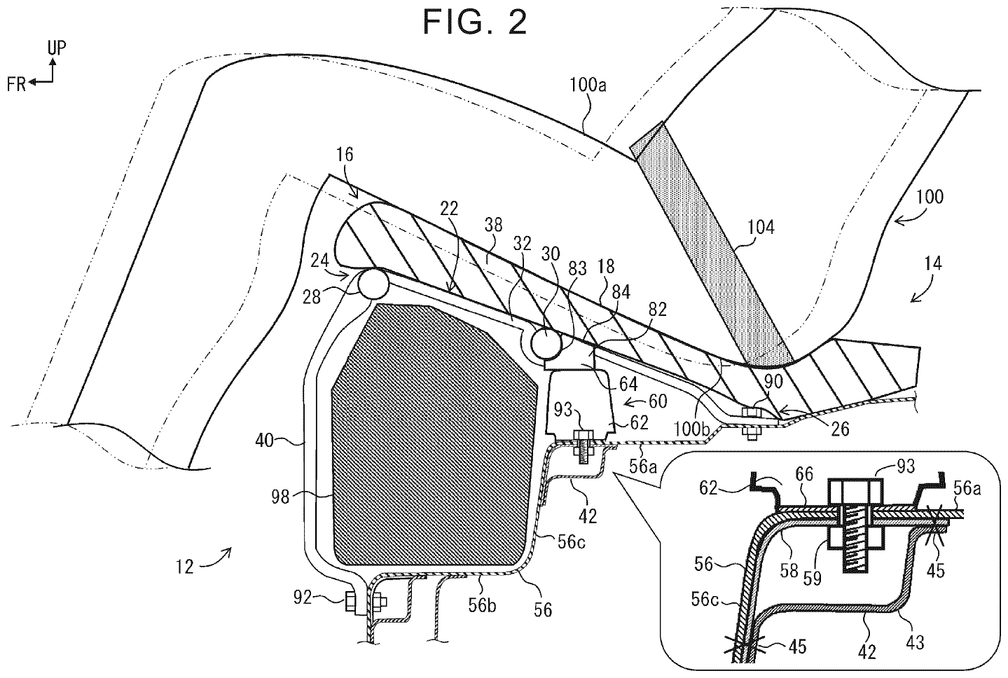

FIG. 1 is a plan view of a vehicle rear structure 12. FIG. 2 is a cross-sectional view taken along line 2-2 of FIG. 1. The vehicles 10 are hybrid battery electric vehicle (HEV powered by engines and motors. Note that the vehicles 10 may be other electrified vehicle such as plug-in hybrid battery electric vehicle (PHEV) and battery electric vehicle (BEV). The vehicle 10 includes a battery that supplies electric power to a motor that is a power source. As shown in FIG. 2, the high-voltage device 98 including the battery is disposed below the seat cushion 16 of the rear seat 14.

10 The vehicle 10 is a relatively small automobile and includes a two-person rear seat 14. In FIG. 1, the two seating surface regions 20 in the rear seat 14 are indicated by dashed lines. The rear seat 14 is disposed on the upper side of the floor panel 56. The floor panel 56 is formed by pressing a steel sheet.

The floor panel 56 is provided between the pair of rockers 48 and between 15 the pair of rear side members 50. Each of the two rockers 48 has a closed cross section as viewed in the front-rear direction and extends in the front-rear direction.

The pair of rear side members 50 are framework members of the vehicle connected to the rear ends of the pair of rockers 48. Each of the two rear side members 50 has a closed cross section viewed from the front-rear direction and extends in the front-rear direction. As shown in FIG. 1, the front portions of the two rear side members 50 are provided so as to be directed inward in the vehicle width direction from the front side toward the rear side and to be inclined upward.

The rear seat 14 includes a seat cushion 16 and a seat back (not shown) connected to a rear portion of the seat cushion 16. The seat cushion 16 includes a cushion 25 frame 22 and a cushion member 38 (see FIG. 2). The cushion member 38 is covered with a seat skin (not shown), and forms a seating surface 18 on which the occupant 100 is seated.

The cushion frame 22 is disposed below the seating surface 18. The cushion frame 22 is made of metal and includes a front pipe 28, a rear pipe 30, two connecting members 34, and two support members 32, as shown in FIG. 1. The front pipe 28 extends in 30 the vehicle width direction, and both left and right end portions thereof are bent backward. The rear pipe 30 is located behind the front pipe 28 and extends in the vehicle width direction. At each of the left end portion and the right end portion of the seat cushion 16, the end portion of the front pipe 28 and the end portion of the rear pipe 30 are welded to the connecting member 34. Each of the two connecting members 34 extends in the front-rear direction, and the rear end thereof is fastened to the upper surface of the rear side member 50 with a bolt 91.

The two support members 32 are spaced apart in the vehicle width direction between the two connecting members 34. Each of the two support members 32 has a substantially plate shape and extends in the front-rear direction through the lower portion of the rear pipe 30. The front end of the support member 32 is welded to the front pipe 28, and the rear end of the support member 32 is fastened to the floor panel 56 with a bolt 90. Each of the two support members 32 is welded to the rear pipe 30 in contact with the lower surface of the rear pipe 30.

Although not shown, the cushion frame 22 includes a plurality of plate-like members extending between the front pipe 28 and the rear pipe 30 in addition to the two support members 32. That is, a metal plate-like member is disposed in a region between the two support members 32 and a region of each of the two support members 32 outside in the vehicle width direction, and in a region between the front pipe 28 and the rear pipe 30. The front end of the plate-like member is welded to the front pipe 28, and the rear end of the plate-like member is welded to the rear pipe 30.

As shown in FIG. 2, the cushion frame 22 is inclined downward from the front toward the rear. The rear pipe 30 is positioned lower than the front end of the front pipe 28, and the left and right end portions of the front pipe 28, the two connecting members 34 (see FIG. 1), and the two support members 32 are inclined downward from the front toward the rear.

The rear pipe 30 is a framework member of the seat cushion 16. As shown in FIG. 2, the rear pipe 30 is positioned below the thigh 100a of the occupant 100 when the occupant 100 is seated on the seating surface 18.

The front end of the front pipe 28 is the front end 24 of the cushion frame 22 and is connected to the floor panel 56 via four front legs 40 (see FIG. 1). The four front legs 40 are made of metal and are spaced apart in the vehicle width direction. Each of the four front legs 40 has an upper end welded to the front pipe 28 and a lower end fastened to the floor panel 56 by bolts 92 (see FIG. 2). The rear ends of the two support members 32 are the rear ends 26 of the cushion frame 22, respectively, and are fastened to the floor panel 56 by bolts 90.

As illustrated in FIG. 2, the floor panel 56 includes, on the lower side of the seat cushion 16, an upper step portion 56a, a lower step portion 56b at a position lower than the upper step portion 56a, and a transition portion 56c between the upper step portion 56a and the lower step portion 56b. The upper step portion 56a is on the lower side of the rear portion of the seat cushion 16, and the lower step portion 56b is on the lower side of the front portion of the seat cushion 16. The high-voltage device 98 is disposed between the front portion of the seat cushion 16 and the lower step portion 56b of the floor panel 56 in the vehicle width direction. The high-voltage device 98 is fixed to the floor panel 56 via a bracket (not shown).

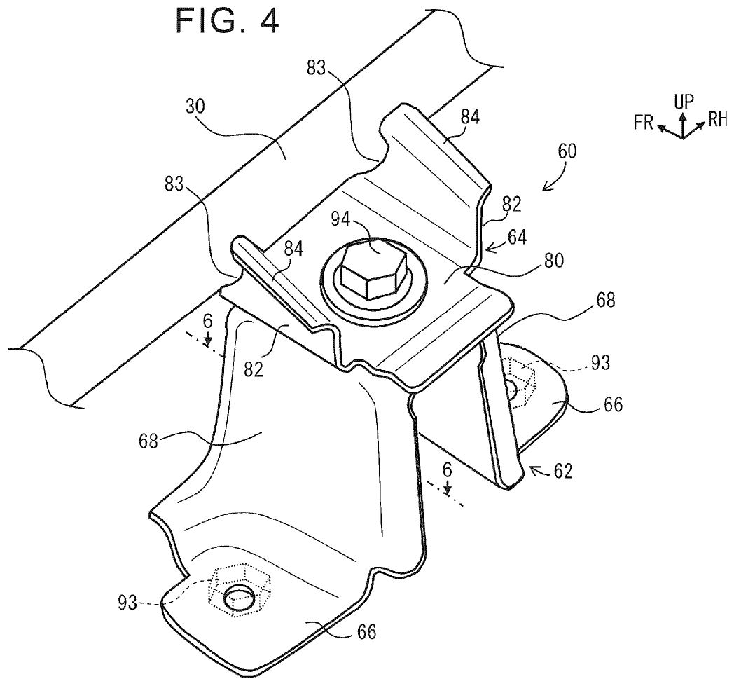

As shown in FIG. 1, the vehicle rear structure 12 includes a bracket 60 (shown schematically as a rectangle in the figure) provided below the center of the seating surface region 20 in which the occupant is seated in the vehicle width direction. In FIG. 1, the bracket 60 is provided only in the left seating surface region 20, but the bracket 60 may also be provided in the right seating surface region 20. As shown in FIG. 2, the bracket 60 is a metal member connected to the rear pipe 30. As shown in FIGS. 2 and 4, the bracket 60 includes an upper bracket 64 and a lower bracket 62. The upper bracket 64 is welded to the rear pipe 30 and is fastened to the lower bracket 62 by bolts 94 (see FIG. 4). The lower bracket 62 is fastened to the floor panel 56 (see FIG. 2) by two bolts 93. The bracket 60 will be described in detail later.

In FIG. 2, the lower side of the lower bracket 62 is shown enlarged by blowing. A fixing member 58 and a floor cross-member 42 (simply referred to as a cross-member 42) are disposed on the rear side of the corner portion between the upper step portion 56a and the transition portion 56c of the floor panel 56.

The fixing member 58 is a plate-like member provided only on the lower side of the bracket 60 and having a substantially L-shaped cross section along the rear surface of the floor panel 56. The fixing member 58 is connected to the rear side of the floor panel 56 by spot welding. Two nuts 59 (only one of the nuts 59 is shown in FIG. 2) for receiving the two bolts 93 of the lower bracket 62 are fixed to the rear surface of the fixing member 58.

The cross-member 42 is disposed on the rear side of the floor panel 56 and forms a closed cross section with the floor panel 56. As shown in FIG. 1, the cross-member 42 extends in the vehicle width direction and is bridged between the pair of rear side members 50.

As shown in FIG. 2, the cross-member 42 includes a main body 43 and two flange portions 45 that are continuous with the upper end and the lower end of the main body 43. The two flange portions 45 are spot-welded to the floor panel 56 at intervals in the vehicle width direction. On the lower side of the bracket 60, the two flange portions 45 are spot-welded to the floor panel 56 with the fixing member 58 interposed therebetween.

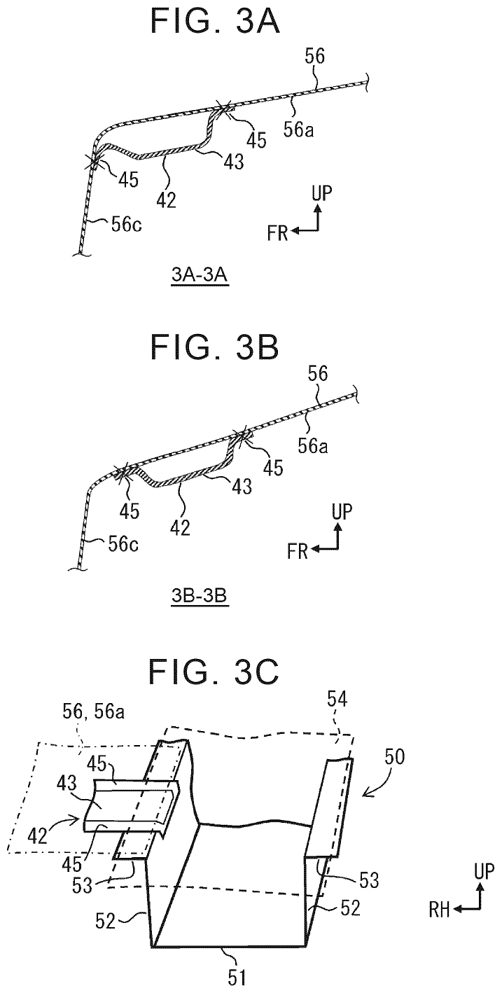

In FIG. 3A, a cross section of the floor panel 56 and the cross-member 42 along 3A-3A of FIG. 1 is shown. In FIG. 3B, a cross section of the floor panel 56 and the cross-member 42 along 3B-3B of FIG. 1 is shown. As can be seen from FIGS. 2, 3A, and 3B, the front end of the upper step portion 56a of the floor panel 56 is gradually lowered from the inside to the outside (from the 2-2 line to 3A-3A line) in the vehicle width direction. The position of the transition portion 56c of the floor panel 56 in the front-rear direction is the same or substantially the same in the vehicle-width direction on the lower side of the seat cushion 16. As a result, the upper step portion 56a of the floor panel 56 is inclined upward from the front toward the rear at the vehicle-width-direction outer end portion.

In FIG. 3C shown, a portion of the front portion of the left rear side member 50 is shown. As described above, the front portion of the rear side member 50 is inclined upward from the front toward the rear. The upper step portion 56a of the floor panel 56 is superposed on the vehicle-width-direction inner flanges 53 of the rear side members 50 inclined upward.

As shown in FIG. 1, the cross-member 42 extends obliquely rearward at a portion outward in the vehicle width direction in a plan view. The cross-member 42 is provided so as to straddle the transition portion 56c and the upper step portion 56a of the floor panel 56 in the cross section taken along the line 2-2 of FIG. 2. However, as shown in FIGS. 3A and 3B, the cross-member 42 is gradually displaced rearward while the cross-sectional profile changes in a hat-like manner from the inner side toward the outer side in the vehicle width direction in a part outward in the vehicle width direction. The cross-member 42 is coupled to the rear side of the upper step portion 56a of the floor panel 56 in a cross section along 3A-3A line.

The cross-member 42 is inclined upward from the front toward the rear at an end portion outward in the vehicle width direction. As shown in FIG. 3C, the cross-member 42 is superimposed on the vehicle-width-direction inner flanges 53 of the rear side members 50 inclined upward.

As shown in FIG. 3C, the rear side member 50 includes a hat-shaped main body 51 having an open upper side and a top plate panel 54 disposed on the upper side of the main body 51. The main body 51 includes two side plates 52 and two flanges 53 extending outward from the upper ends of the two side plates 52. The flange 53 on the vehicle width direction inner side of the main body 51 has a recess (not shown) for receiving the main body 43 of the cross-member 42 having a convex shape downward.

The vehicle width direction outer end portion of the upper step portion 56a of the floor panel 56 and the vehicle width direction outer end portion of the cross-member 42 are superposed on the vehicle width direction inner flange 53 of the rear side member 50, and are spot-welded thereto. Further, the outer end of the cross-member 42 in the vehicle width direction is bent downward and is in contact with the inner surface of the side plate 52, and is spot-welded thereto. The top plate panel 54 is spot-welded to each of the two flanges 53 at intervals along the front-rear direction. Between the top plate panel 54 and the vehicle width direction inner flange 53, the vehicle width direction outer end of the upper step portion 56a of the floor panel 56, and the vehicle width direction outer end of the cross-member 42 is sandwiched.

Although the left portions of the floor panel 56 and the cross-member 42 in the vehicle 10 have been described above, the right portions of the floor panel 56 and the cross-member 42 have the same structure symmetrically.

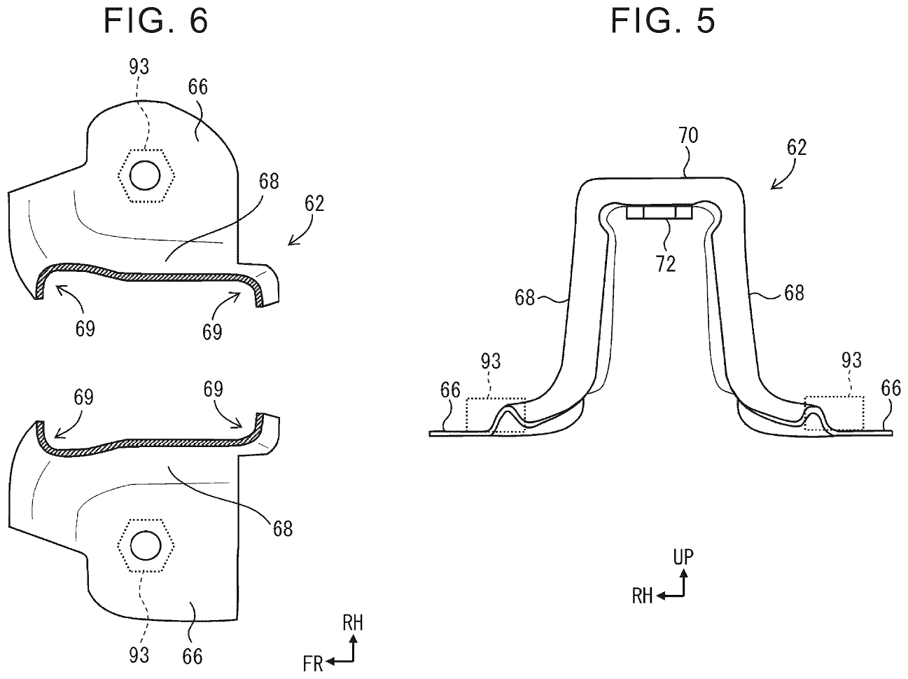

FIG. 4 is a perspective view showing the bracket 60 connected to the rear pipe 30. FIG. 5 is a front view illustrating the lower bracket 62. FIG. 6 is a cross-sectional view of the lower bracket 62 taken along line 6-6 of FIG. 4. As shown in FIG. 4, the bracket 60 includes an upper bracket 64 and a lower bracket 62.

The upper bracket 64 includes a bottom plate 80 and two side plates 82 extending upward from left and right end portions of the bottom plate 80. The bottom plate 80 is in contact with the upper surface of the top plate 70 (see FIG. 5) of the lower bracket 62, and is fastened to the top plate 70 with bolts 94. Specifically, bolt insertion holes (not shown) through which the bolts 94 are inserted are formed in the bottom plate 80 of the upper bracket 64 and the top plate 70 of the lower bracket 62, respectively, and a nut 72 is fixed to the rear side of the top plate 70 of the lower bracket 62. The bolt 94 is passed through the bolt insertion holes of the bottom plate 80 and the top plate 70 from the upper side of the upper bracket 64, and is screwed into the nut 72 of the top plate 70.

Each of the two side plates 82 of the upper bracket 64 is notched so that the front end face 83 receives the rear lower portion of the rear pipe 30. Each of the two front end faces 83 is in contact with the outer peripheral surface of the rear lower portion of the rear pipe 30, and is coupled to the outer peripheral surface thereof by arc welding.

Each of the upper ends of the two side plates 82 is a flange portion 84 bent outward in the left-right direction. As shown in FIG. 2, the two flange portions 84 face the lower surface of the cushion member 38 of the seat cushion 16.

As shown in FIGS. 5 and 6, the lower bracket 62 includes two side plates 68 symmetrically provided, a top plate 70 connecting the upper ends of the two side plates 68, and two bottom plates 66 extending from the lower ends of the two side plates 68 to the left and right outward. As shown in FIG. 6, the front and rear end portions 69 of the two side plates 68 are bent inward. Therefore, the lower bracket 62 has high rigidity with respect to a downward load input from the rear pipe 30 via the upper bracket 64.

The two bottom plates 66 of the lower bracket 62 are respectively in contact with the floor panel 56 (refer to the blow-out diagram in FIG. 2), and are fastened to the floor panel 56 by bolts 93. Specifically, with respect to the two bolts 93, the bottom plate 66, the floor panel 56, and the fixing member 58 of the lower bracket 62, each bolt insertion hole for inserting the bolt 93 is formed, the rear side of the fixing member 58, the nut 59 is fixed. Each of the two bolts 93 passes through the bolt insertion holes of the bottom plate 66, the floor panel 56, and the fixing member 58 from the upper side of the lower bracket 62, and is screwed into the nut 59.

As shown in FIG. 2, the bracket 60 is disposed on the cross-member 42. Next, the operation and effect of the above-described embodiment will be described.

When the vehicle 10 collides with the front surface, as shown in FIG. 2, an inertial force toward the lower side and the front side acts on the occupant 100 seated on the rear seat 14. Due to this inertial force, as indicated by the two-dot chain line, the buttocks 100b of the occupant 100 are moved to the front side while sinking into the seat cushion 16, and are received by the rear pipe 30 via the cushion member 38.

At this time, the downward load input from the occupant 100 to the rear pipe 30 is transmitted to the cross-member 42 via the bracket 60, and is received by the floor panel 56 and the pair of rear side members 50 coupled to the cross-member 42. Accordingly, it is possible to suppress the rear pipe 30 from being deformed downward. By suppressing the deformation of the rear pipe 30, the load input to the front leg 40 of the rear seat 14 can be reduced, and the deformation of the front leg 40 can be suppressed. Therefore, it is possible to suppress the cushion frame 22 from approaching the high-voltage device 98.

In particular, in the embodiment described above, since the bracket 60 is provided below the vehicle width direction center of the seating surface region 20 (see FIG. 1) where the occupant 100 is seated, downward deformation of the rear pipe 30 can be effectively suppressed.

Further, according to the embodiment described above, since the deformation of the rear pipe 30 is suppressed at the time of the front collision of the vehicle 10, the amount of the occupant 100 sinking into the seat cushion 16 can be reduced. Therefore, it is possible to suppress the lap belt 104 (see FIG. 2), which is a seat belt worn by the occupant 100, from moving out of the pelvis, which is a desired position, to the abdomen of the occupant 100.

Further, according to the embodiment described above, since the bracket 60 includes the upper bracket 64 and the lower bracket 62, it is possible to increase the degree of freedom in assembling the bracket 60 at the time of manufacturing the vehicle 10. For example, after the lower bracket 62 is fastened to the floor panel 56 with two bolts 93 in advance, the lower bracket 62 and the upper bracket 64 can be fastened with the bolts 94 at a relatively high position. Conversely, after the lower bracket 62 and the upper bracket 64 are fastened with bolts 94 in advance, the lower bracket 62 can be fastened with two bolts 93 to the floor panel 56 at a relatively low position.

Further, according to the embodiment described above, as shown in FIG. 4, the upper ends of the two side plates 82 of the upper bracket 64 are each a flange portion 84 bent outward in the left-right direction. The two flange portions 84 face the lower surface of the cushion member 38 of the seat cushion 16 (see FIG. 2). Therefore, the cushion member 38, which is lowered by the load of the occupant 100 when the vehicle 10 collides with the front surface, can be supported by the two flange portions 84.

In the above-described embodiment, as shown in FIG. 2, the rear pipe 30 is provided in front of the buttocks 100b of the occupant 100, and the high-voltage device 98 is provided with a large space in the front-rear direction. Therefore, the bracket 60 is positioned rearward with respect to the rear pipe 30, and supports the rear lower portion of the rear pipe 30.

However, the bracket 60 may be positioned directly under or under the front of the rear pipe 30, for example, by providing a smaller front-to-rear placement space for the high-voltage device 98 or by positioning the rear pipe 30 more rearwardly. Accordingly, the bracket 60 may support the lower portion directly below the rear pipe 30 or the lower portion in front.

Note that the bracket 60 may not be provided for all the seating surface regions 20 (see FIG. 1) in which the occupant of the rear seat 14 can be seated. That is, the bracket 60 may be provided only in the left seating surface region 20 as shown in FIG. 1, or may be provided only in the right seating surface region 20. For example, in the design stage of the vehicle 10, a gap between the seat cushion 16 and the high-voltage device 98 in the center of the seating surface region 20 in the vehicle width direction is checked with respect to each of the plurality of seating surface regions 20. The bracket 60 may be provided to the seating surface region 20 having a narrow gap (which is less than the predetermined gap), and the bracket 60 may not be provided to the seating surface region 20 having a wide gap (which is greater than or equal to the predetermined gap). It is also possible to provide two or more brackets 60 side by side with respect to one seating surface region 20.

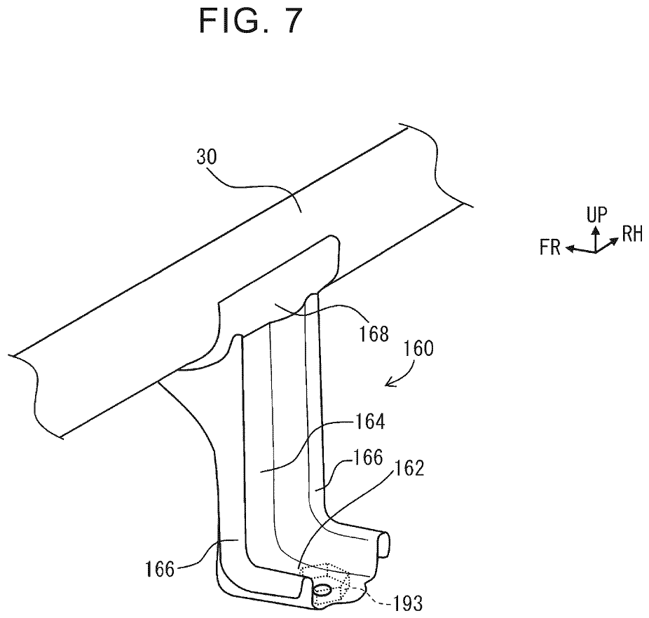

Further, in the embodiment described above, the bracket 60 is composed of two components of the upper bracket 64 and the lower bracket 62, the bracket 60 may be composed of one component. FIG. 7 shows an example of a bracket 160 composed of one component.

As shown in FIG. 7, the bracket 160 includes a bottom portion 162, a column portion 164 extending upward from the front end of the bottom portion 162, two side portions 166, and a head portion 168 provided above the column portion 164 and the two side portions 166. The two side portions 166 project upward from the left and right end portions of the bottom portion 162 and project rearward from the left and right end portions of the column portion 164. A bolt insertion hole through which the bolt 193 is inserted is formed in the bottom portion 162 of the bracket 160. The bolt 193 is passed from the upper side of the bracket 160 through the bottom portion 162, the floor panel 56 (see FIG. 2), and the bolt insertion hole of the fixing member 58, and is screwed into the nut 59 of the fixing member 58.

The two side portions 166 of the bracket 160 have a partially double structure in which the end portions thereof are folded outward, and the folded portions thereof protrude forward from the column portions 164 at the upper portions of the side portions 166. The head portion 168 of the bracket 160 is connected to the upper ends of the column portion 164 and the two side portions 166, and has a plate shape bent so as to be in contact with the outer peripheral surface of the rear lower portion of the rear pipe 30. The head portion 168 of the bracket 160 is joined to the rear lower portion of the rear pipe 30 by welding.

Also in the embodiment using the bracket 160, when the vehicle 10 collides with the front surface, the downward load input from the occupant to the rear pipe 30 can be transmitted to the cross-member 42 via the bracket 160. Then, it can be received by the cross-member 42. Therefore, it is possible to suppress the rear pipe 30 from being deformed, and it is possible to suppress the seat cushion 16 from approaching the high-voltage device 98.

What is claimed is:

1. A vehicle rear structure in which a high-voltage device is disposed below a seat cushion of a rear seat of a vehicle, wherein:
the seat cushion includes a cushion frame that is disposed below a seating surface on which an occupant is seated;
the high-voltage device is disposed between the cushion frame and a floor panel;
a front end of the cushion frame is connected to the floor panel via one or more front legs;
the cushion frame is inclined downward from forward to rearward, and a rear end of the cushion frame is connected to the floor panel;
the cushion frame includes a framework member that extends in a vehicle-width direction and that is situated below thighs of the occupant when the occupant is seated on the seating surface; and
the vehicle rear structure includes
a cross-member that bridges between a pair of rear side members extending in a front-rear direction in a rear portion of the vehicle. and
a bracket that is disposed on the cross-member and that is connected to the framework member.

2. The vehicle rear structure according to claim 1, wherein the bracket is provided below a vehicle-width-direction middle portion of a seating surface region on which the occupant is seated.

3. The vehicle rear structure according to claim 1, wherein the bracket includes an upper bracket that is welded to the framework member, and a lower bracket that is bolted to the upper bracket and also is bolted to the floor panel that is disposed above the cross-member.

4. The vehicle rear structure according to claim 3, wherein:
the framework member is a pipe;
the upper bracket includes a bottom plate and two side plates extending upward from right and left end portions of the bottom plate;
the bottom plate of the upper bracket is bolted to the lower bracket; and
a forward end face of each of the two side plates of the upper bracket is welded to an outer peripheral face on a rearward lower portion of the pipe, and also the two side plates are bent outward at an upper end to the right and left to create flange portions that face a lower face of a cushion material of the seat cushion.
